(19) United States
(12) Patent Application Publication
(10) Pub. No.: US 2016/0088785 A1
(43) Pub. Date: Mar. 31, 2016

(54) SYSTEM AND METHOD FOR TERMINATING COVER CROPS USING VEHICLE-GENERATED HEAT

(71) Applicant: The United States of America as represented by the Secretary of Agriculture, Washington, DC (US)

(72) Inventors: Ted S. Kornecki, Auburn, AL (US); Stephen A. Prior, Auburn, AL (US); Corey M. Kichler, Auburn, AL (US)

(21) Appl. No.: 14/501,424

(22) Filed: Sep. 30, 2014

(51) Int. Cl. A01B 49/02; A01B 39/06

(52) U.S. Cl. CPC A01B 49/02; A01B 39/06

(57) ABSTRACT

A cover crop termination system uses heat from a vehicle's exhaust to terminate a cover crop. Preferably, the cover crop termination system is mounted on the front portion of a walk-behind tractor. As the tractor is propelled across a field of cover crops, heat from the vehicle's exhaust is directed to a perforated manifold positioned adjacent to the cover crop so that the exhaust heat terminates the cover crop. The exhaust heat may be supplemented by electrical heaters mounted adjacent to the perforated manifold.

The present invention relates to a system and method for terminating cover crops. Specifically, the current invention relates to a system that uses vehicle-generated heat to terminate cover crops.

### BACKGROUND OF THE INVENTION

Cover crops are an important part of most no-till soil conservation systems, but they must be managed correctly to fully realize their potential benefits. Among other things, these benefits include a reduction in soil erosion and the suppression of weed pressure.

At the end of a selected cover crop-growing cycle, the cover crops are terminated so that a selected newly planted crop can emerge and thrive. Termination of the cover crop allows the new selected crops to fully benefit from the soil conditioning properties of the terminated cover crops without competing with the cover crops for water and nutrients.

In the past, herbicides were the preferred means of terminating cover crops, primarily because the herbicide application process is relatively fast and effective. Although herbicide application effectively kills the cover crops, there may be problems associated with unintended over-spray, spray drift, and undesirable chemical run-off. The herbicides also leave the cover crop stalks in tact. The stalks and associated crop residue subsequently interfere with the planting process associated with the new crops, particularly for cover crops (such as rye) that generate a large amount of biomass. Further, the use of herbicides is prohibited for farmers that intend to market their crops as “organically grown”.

Rolling and crimping devices have been developed to destroy and mulch the cover crops and thereby address these issues. These devices generally require large conventional tractors to tow the rollers and/or crimpers across the cover crops. However, these large tractors are not practical for small-scale organic farmers (particularly vegetable farmers) who could benefit from the use of no-till soil conservation practices.

The need exists for a means to terminate cover crops that is directed to smaller scale organic farming operations. The current invention provides a system whereby heat (which is currently wasted) is directed from a vehicle (preferably an inexpensive walk-behind garden tractor) to the system described herein to terminate a cover crop.

### SUMMARY OF THE INVENTION

The current invention is directed to a walk-behind tractor crop terminating system. The system includes an elongated blade that extends perpendicular to the direction of travel of the walk-behind tractor. A flexible heat/exhaust duct connects an engine exhaust system of the walk-behind tractor to a perforated manifold that is integral with the blade. In operation, as the blade slides over and flattens the cover crop, heat and exhaust gasses from the perforated manifold are directed through the blade to terminate the cover crop.

The current invention is also directed to a method of terminating cover crops. In accordance with the method, an elongated blade is attached to a front portion of a walk-behind tractor. The blade extends perpendicular to the direction of travel of the walk-behind tractor. The blade includes a perforated manifold that extends parallel with the blade and is integral with the blade. A flexible heat/exhaust duct extends from the engine exhaust system of the walk-behind tractor to the perforated manifold. As the walk-behind tractor is propelled across a field of cover crops and the blade slides over and flattens the cover crop, heat and exhaust gasses from the perforated manifold terminate the cover crop.

### BRIEF DESCRIPTION OF THE DRAWINGS

FIG. 1 is a top perspective view of the vehicle heat crop termination system.

FIG. 2 is a bottom perspective view of the vehicle heat crop termination system.

### DETAILED DESCRIPTION OF PREFERRED EMBODIMENTS

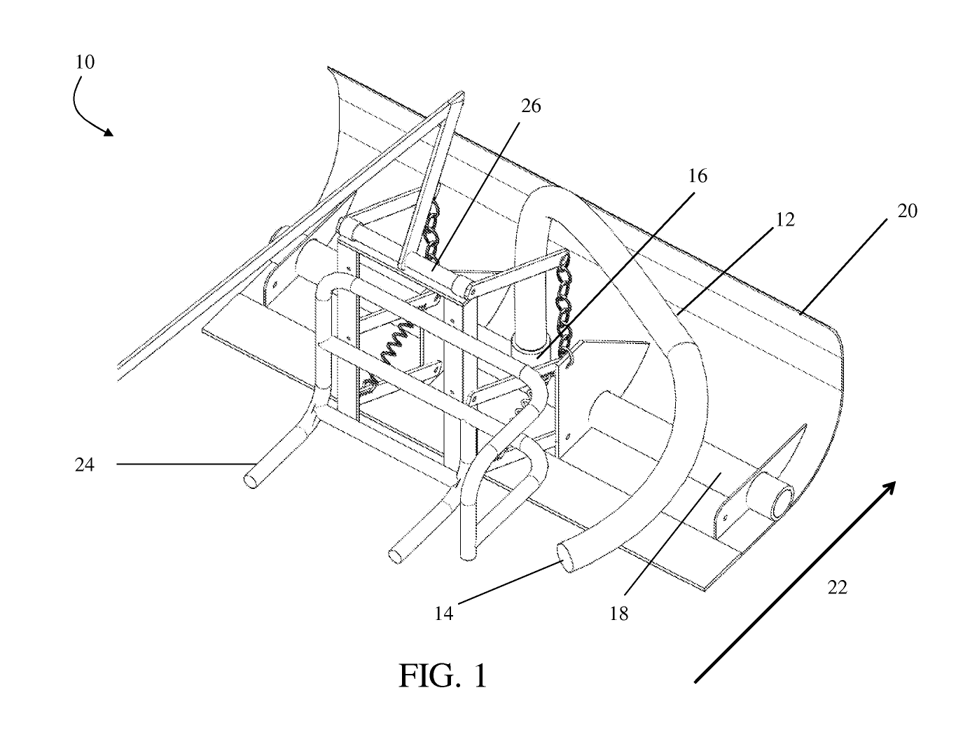

The vehicle heat crop termination system 10 is generally shown in FIG. 1. The vehicle heat crop termination system 10 uses vehicle exhaust heat (which may be supplemented) to terminate a cover crop.

In the preferred embodiment, the exhaust of a walk-behind tractor is used to terminate the cover crop. Typical examples of these types of tractors are manufactured by DR, Troy-Built, and BCS. For the purposes of the current disclosure, a walk-behind tractor is a tractor that does not accommodate a riding operator so that the operator walks behind the tractor and guides the tractor with a linkage that may include handlebars, hand grips, or the like.

As shown in FIG. 1, in the preferred embodiment, a flexible heat/exhaust duct 12 directs heat away from the tractor exhaust system. Specifically, the flexible heat/exhaust duct 12 has a first end 14 that is adapted to connect to an exhaust aperture of the walk-behind tractor. The exhaust duct 12 is insulated with three layers of fire resistant cloth. The insulation minimizes heat loss and facilitates the safe use of the system 10.

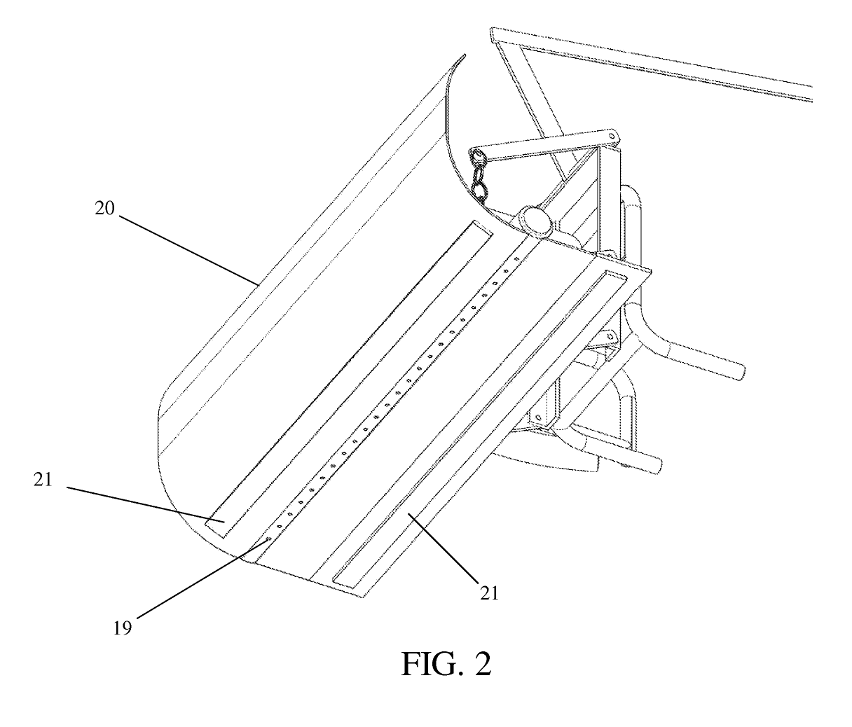

A second end 16 of the heat/exhaust duct 12 attaches to a horizontally extending manifold 18. Hot exhaust gasses generated by the tractor are ultimately directed out of perforations 19 (as shown in FIG. 2) in the manifold 18 and on to the cover crop. The perforations 19 are arrayed along the length of the manifold 18. Essentially, in the preferred embodiment, there is a gap in the blade 20. Perforations 19 in the manifold 18 are exposed to the cover crop through the gap in the blade 20. In alternative embodiments, the blade 20 may be unitary so that there are perforations in the blade 20 that correspond to perforations in the manifold 18.

The manifold 18 is configured so that the manifold 18 extends parallel with the blade 20. Although the manifold 18 is shown in FIG. 1 as having a circular cross section, the manifold 18 may have any shape known in the art consistent with the function described herein.

Specifically, the manifold 18 may have (roughly) a rectangular shape and thereby maximize the surface area of the manifold 18 that is positioned adjacent to a cover crop. The manifold 18 may also be insulated (in a similar manner to the exhaust duct 12) to ensure that all available heat is focused on the portion of the manifold 18 that is adjacent to the cover crops. The direct application of the exhaust gasses themselves (even without the heat) may be toxic to some cover crops.

The blade 20 has a general “L” shape, however the vertex of the “L” is rounded so that the blade 20 effectively flattens cover crops as the walk-behind tractor moves in the direction of the arrow 22. In the preferred embodiment, the blade 20 is comprised of light-weight aluminum.

As shown in FIG. 1, the blade 20 attaches to a walk-behind tractor engine guard 24 through a pivoting linkage 26. The engine guard 24 is secured to a front portion of the walk-behind tractor. The pivoting mechanism 26 enables a user to effectively raise and lower the blade 20.

As best shown in FIG. 2, in at least one embodiment, the heat generated by the walk-behind tractor's exhaust is supplemented by strip heaters 21 (110 VAC, 1500 W each) that are positioned on both sides of the manifold perforations 19. The strip heaters 21 are powered by a generator that is connected to the walk-behind tractor's power take-off. Strip heaters are well known in the mechanical arts. For the sake of simplicity, the conventional wiring harness associated with the strip heaters 21 is not shown in FIG. 1.

In the preferred embodiment, the walk-behind tractor configuration described herein generates exhaust gases having a temperature of about 650° F.—which are distributed along the length of the manifold 18. The strip heaters 21 generate continuous heat at about 1000° F. distributed along the length of the heater element 21. Either the exhaust components 12, 18, 19 or the strip heaters 21 may be used alone or in combination to terminate a cover crop. Since the vehicle heat crop termination system 10 described herein is mounted in the front of the tractor, the system 10 may be used in conjunction with the powered rolling and crimping device described in U.S. Pat. No. 8,176,991 to Kornecki, which is hereby incorporated by reference. The powered rolling and crimping device is designed to mount behind the tractor.

In operation, as the walk-behind tractor pushes the vehicle heat crop termination system 10 in the direction of the arrow 22, the blade 20 flattens a cover crop. As the blade 20 moves over the cover crop, exhaust heat and gasses from the walk-behind tractor flow through a heat/exhaust duct 12 and into a horizontal manifold 18 that is integral with the blade 20. The exhaust gases are eventually expelled through manifold perforations 19 and associated that are adjacent to the cover crop.

Simultaneously, heat is generated by one or more strip heaters 21 that are configured so that heat from the heaters is also directed to the cover crop. The heat generated by the exhaust gases in combination with the strip heaters 21 acts to terminate the cover crop. The vehicle heat crop termination system 10 which is mounted to a front portion of the walk-behind tractor, may be used in conjunction with a powered rolling and crimping device which mounts at the rear of the tractor.

For the foregoing reasons, it is clear that the current invention provides an innovative means of destroying a cover crop. The invention may be modified in multiple ways and applied in various technological applications. The current invention may be customized as required by a specific operation or application, and the individual components may be modified and defined, as required, to achieve the desired result.

For example, although the preferred embodiment is intended for use with a walk-behind tractor, in alternative embodiments the scale of the components may be increased or decreased. An implement with the design described herein may be used with other types of powered devices including conventional riding-type farm tractors as well as devices that would not conventionally be considered to be “tractors” (such as all-terrain vehicles (ATVs)). Such variations are not to be regarded as a departure from the spirit and scope of the invention, and all such modifications as would be obvious to one skilled in the art are intended to be included within the scope of the following claims.

What is claimed is:

1. A walk-behind tractor crop terminating system comprising:
an elongated blade extending perpendicular to a direction of travel of the walk-behind tractor;
a perforated manifold extending parallel to the blade; and,
a flexible heat/exhaust duct connecting an engine exhaust system of the walk-behind tractor to the perforated manifold;
whereby as the blade slides over and flattens the cover crop, exhaust gasses from the perforated manifold are directed out of the manifold and past the blade to terminate the cover crop.

2. The system of claim 1 wherein the system is configured so that there is a gap in the blade adjacent to the perforated manifold, the exhaust gases moving out of perforations in the perforated manifold and through the gap to terminate the cover crops.

3. The system of claim 1 wherein the system is configured so that the blade is unitary, the exhaust gases moving out of perforations in the perforated manifold and through corresponding perforations in the blade to terminate the cover crop.

4. The system of claim 1 wherein a vertex of the blade has a rounded shape so that the blade slides over and flattens the cover crops.

5. The system of claim 1 wherein the blade comprises light-weight aluminum.

6. The system of claim 1 wherein perforations are arrayed along the length of the perforated manifold.

7. The system of claim 1 wherein a portion of the perforated manifold that is integral with the blade is adjacent to the cover crop.

8. The system of claim 1 wherein the flexible heat/exhaust duct connecting an engine exhaust system of the walk-behind tractor to the perforated manifold is insulated to prevent a loss of heat.

9. The system of claim 1 wherein the system further comprises at least one supplemental heating unit to terminate the cover crop.

10. The system of claim 9 wherein the supplemental heating unit receives electrical power from a generator powered by the walk-behind tractor power take off.

11. The system of claim 1 wherein two supplemental heating units are positioned on the blade, the heating units are positioned so that one heating unit is placed on each side of the perforated manifold.

12. The system of claim 1 wherein the perforated manifold is insulated with a heat-insulating material.

13. The system of claim 1 wherein the system is configured so that the blade is raised and lowered by a linkage attached to an engine guard on a front portion of the walk-behind tractor.

14. A method of terminating a cover crop wherein the walk-behind tractor crop terminating system of claim 1 is propelled across a field of cover crops and thereby terminates the cover crops.

15. A walk-behind tractor cover crop terminating system wherein exhaust heat from the tractor is ducted to a perforated manifold mounted on a crop-flattening blade, the exhaust heat terminating the cover crop.

16. A method of terminating a cover crop, the method comprising the steps of:
(a) providing a walk-behind tractor;
(b) attaching an elongated blade to a front portion of the tractor, the blade extending perpendicular to a direction of travel of the walk-behind tractor;
(c) connecting a manifold to the blade, the manifold extending parallel to the blade, perforations in the manifold being exposed to a cover crop through a gap in the blade;
(d) connecting a flexible heat/exhaust duct from an engine exhaust system of the walk-behind tractor to the perforated manifold;
(e) propelling the walk-behind tractor across a field of cover crops so that as the blade slides over and flattens the cover crop, exhaust gasses from the perforated manifold terminate the cover crop.

17. The method of claim 16 wherein, in step (b), a leading portion of the blade has a rounded shape so that the blade slides over and flattens the cover crops.

18. The method of claim 16 wherein, in step (b), the blade comprises light-weight aluminum material.

19. The method of claim 16 wherein, in step (c), a portion of the perforated manifold that is integral with the blade is adjacent to the cover crop.

20. The method of claim 16 wherein, before step (e), providing heaters adjacent to the cover crops to supplement heat provided by the perforated manifold exhaust gasses.
